(19) United States
(12) Patent Application Publication
(10) Pub. No.: US 2009/0041307 A1
(43) Pub. Date: Feb. 12, 2009

(54) Biometric information transfer system

(76) Inventors: Kenji Iwano, Kanagawa (JP); Hiroyoshi Yajima, Kanagawa (JP); Naoki Matsubara, Tokyo (JP)

Correspondence Address: MCDERMOTT WILL & EMERY LLP, 600 13TH STREET, NW, WASHINGTON, DC, 20005-3096, US

(21) Appl. No.: 11/918,364

(22) PCT Filed: Apr. 27, 2006
(86) PCT No.: PCT/JP2006/308864

§ 371 Date: Oct. 12, 2007

(30) Foreign Application Priority Data
May 13, 2005 (JP) 2005-140994

(51) Int. Cl. G06K 9/00

(52) U.S. Cl. 382/115

(57) ABSTRACT

A biometric information transfer system is provided, allowing the urgency, etc., of a biometric information measurement result contained in e-mail to be directly and instantaneously noticed. When the biometric information measurement result is converted into e-mail format, attention-drawing information is assigned to the e-mail in accordance with the biometric information measurement result.

### TECHNICAL FIELD

The present invention relates to biometric information transfer systems for transferring measured biometric information (i.e., biometric information measurement values) in e-mail format to a medical institution or a related institution via a communication line network. More specifically, the present invention relates to a biometric information transfer system in which header information is indicated in e-mail format to accord with a biometric information measurement result, so that a medical institution or suchlike can instantaneously and directly recognize the urgency and priority of the biometric information measurement result.

### BACKGROUND ART

A conventional biometric information transfer system is proposed in, for example, Patent Document 1, and as shown in FIG. 8, it is composed of biometric information measurement means 801 for measuring biometric information such as blood pressure level and pulse level, a communication unit (e.g., a PHS phone, not shown) incorporated in the biometric information measurement means 801, a relay station 805, a modem 837, and a host computer 803 for converting information obtained from the biometric information measurement means 801 into e-mail format.

Biometric information obtained by the biometric information measurement means 801 is transferred from the communication unit through the relay station 805 and a public telephone line 835, such as an ISDN line, to the modem 837, and converted into e-mail format in the host computer 803 connected to the modem 837. The e-mail thus generated contains the biometric information, and the e-mail is assigned a pre-registered e-mail address and transmitted to a mail server 839. It is alleged that by installing the mail server 839 in a medical institution, such as a hospital, in a manner as described above, it becomes possible to centrally manage the biometric information via e-mail.

Patent Document 1: Japanese Laid-Open Patent Publication No. 2001-17398

### DISCLOSURE OF THE INVENTION

### Problem to be Solved by the Invention

In the conventional biometric information transfer system as described above, however, the biometric information is transmitted in e-mail format to the mail server 839, but still, similar biometric information is continually sent to the medical institution from a number of test subjects, such as patients, so that a significant amount of biometric information is concentrated in and collected by the mail server 839. Therefore, the medical institution is required to open all the incoming e-mails one by one to confirm their contents. As a result, the medical institution is forced to spend considerable labor and time. In addition, under such circumstances, even if an e-mail containing biometric information that requires urgent attention is transferred, the e-mail cannot be quickly noticed because it is intermixed with other e-mails, making it difficult to make a prompt response.

Therefore, the present invention has been made to solve the above-described conventional problem, and an objective thereof is to provide a biometric information transfer system for transferring and managing measured biometric information via e-mail, in which the urgency or priority (e.g., a medical abnormality of measured biometric information, i.e., an abnormality of a biometric information measurement value, or a malfunctioning state of a biometric information measurement device itself, which affects biometric information measurement results) can be sensed and automatically reflected in header information of the e-mail.

More specifically, the objective is to provide a biometric information transfer system in which, if e-mail contains highly urgent or important biometric information, a specific indicator is assigned to the title of the e-mail, and furthermore to priority information in the e-mail, so that the receiver of the e-mail, such as a medical institution, can instantaneously recognize the urgency or priority without opening the e-mail to confirm its contents.

### Means for Solving the Problem

To solve the above-described problem, the present invention provides a biometric information transfer system for transferring a biometric information measurement result in e-mail format to a mail server via a telecommunication line, the system comprising a biometric information terminal device, which includes:

biometric information measurement means for measuring biometric information;

control means for controlling the biometric information; and

data conversion means for converting the biometric information measurement result into e-mail format, wherein,

the data conversion means assigns attention-drawing information to the e-mail in accordance with the biometric information measurement result.

Thus, for example, a medical institution can instantaneously recognize the priority and urgency of biometric information measurement results contained in e-mails transferred to its own mail server without opening the e-mails to confirm their contents.

Here, the term “attention-drawing information” encompasses messages containing words such as “urgent”, “attention” and “normal”, which are added to the titles of e-mails, as well as messages such as “priority (e.g., low, normal, and high)”, which is indicated in the e-mails, and such messages allows the medical institution or suchlike to visually and directly perceive the priority and urgency (e.g., an abnormality of a biometric information measurement value) of the biometric information measurement results contained in the e-mails.

In addition, the term “telecommunication line” encompasses wired and wireless communications as well as optical fiber communication networks. The term further encompasses public lines.

Preferably, the biometric information terminal device further includes condition detecting means for detecting a measurement condition for the biometric information.

Thus, a person capable of conducting a diagnosis can decide an analysis condition for the biometric information measurement result based on the measurement condition. For example, a physician and related other people can decide an analysis condition (e.g., a threshold for the biometric information measurement result) in advance based on the measurement condition (e.g., in the case of the blood glucose level, whether it has been measured before or after a meal), so that, based on that analysis condition, the data conversion means can select an analysis condition for the biometric information measurement result. Thus, the medical institution or suchlike can analyze biometric information measurement values, considering a medically necessary analysis condition.

Preferably, the biometric information terminal device further includes transfer destination information holding means for holding at least a first transfer destination of the e-mail, and the data conversion means assigns at least the first transfer destination to the e-mail.

Thus, it is possible to further ensure that the biometric information measurement result is automatically transferred to a predetermined transfer destination. Specifically, it is possible that the user of the biometric information terminal device, e.g., a patient, regularly transfers the biometric information measurement result for the patient to the medical institution. In addition, it is also possible to preset a plurality of transfer destinations. Note that the term “user” in the context of the present invention encompasses a patient, a test subject, or the like, who uses the biometric information transfer system (in particular, the biometric information measurement means) of the present invention.

Preferably, the biometric information terminal device further includes abnormality sensing means for sensing an abnormality of the biometric information measurement result, and when the abnormality sensing means senses one or more abnormalities, the data conversion means assigns the e-mail a second transfer destination different from the first transfer destination.

Thus, it is possible to transfer the e-mail to a usual transfer destination (e.g., the first transfer destination) when the biometric information measurement result is normal, and it is also possible to transfer the e-mail to a specific transfer destination (e.g., the second transfer destination) in place of or in addition to the usual transfer destination when the biometric information measurement result is abnormal. For example, it is possible to construct a system in which the user of biometric information terminal device, e.g., a patient, regularly transfers the biometric information measurement result for the patient to the medical institution (the first transfer destination), and when an emergency happens to the patient, for example, the emergency is automatically reported to the patient's family or a health center (the second transfer destination).

Preferably, the biometric information terminal device further includes transfer operation means for giving a transfer instruction, and in accordance with the instruction from the transfer operation means, the data conversion means converts the biometric information measurement result into the e-mail format, and starts transferring the e-mail.

Thus, the user can transfer normal biometric information measurement results, excluding any abnormal biometric information measurement results, to the medical institution at regular intervals or arbitrary times. In addition, it is also possible to retransmit the biometric information measurement results.

Preferably, the data conversion means assigns a mail-opened confirmation request to the e-mail in accordance with the biometric information measurement result.

Thus, it is possible for the medical institution or suchlike to confirm reception of the e-mail.

It is also preferred that the biometric information terminal device further includes status detecting means for detecting a status of the biometric information measurement means, and the data conversion means assigns attention-drawing information to the e-mail in accordance with the status of the biometric information measurement means detected by the status detecting means.

Thus, it is possible to perceive the status of the biometric information measurement means, and analyze the biometric information measurement result, considering the perceived status. In addition, when the biometric information measurement means has an abnormality, it is possible to replace the biometric information measurement means.

Preferably, the biometric information terminal device further includes manufacturing date detecting means for detecting a manufacturing date and time of the biometric information measurement means, determining a difference between a current date and time and the manufacturing date and time, and determining whether a period of validity of the biometric information measurement means has expired, and the data conversion means assigns attention-drawing information to the e-mail in accordance with whether the period of validity has expired.

Thus, it is possible to perceive the status of the biometric information measurement means in terms of, particularly, whether the period of validity has expired, and analyze the biometric information measurement result, considering whether the period of validity has expired. In addition, it is possible to further ensure that the biometric information measurement means is replaced when the period of validity has expired.

### EFFECT OF THE INVENTION

According to the present invention, when the biometric information measurement value indicates an abnormality, or the biometric information measurement device is in an abnormal status that affects measurement results, for example, the title of e-mail header information is changed or priority information is added to the e-mail. Thus, the receiver, e.g., a medical institution, can instantaneously recognize, by merely the header information, that the e-mail contains an abnormal measurement value, without opening the e-mail to confirm its contents, and a prompt response can be made.

### BRIEF DESCRIPTION OF THE DRAWINGS

FIG. 1 is a block diagram of a biometric information transfer system according to first embodiments of the present invention.

FIG. 2 is a block diagram of a biometric information terminal device according to first embodiments of the present invention.

FIG. 3 is an exemplary blood glucose level data management table for the biometric information transfer system according to first embodiments of the present invention.

FIG. 4 illustrates an exemplary e-mail header and an exemplary body for a biometric information transfer system according to a first embodiment of the present invention.

FIG. 5 is a flowchart for explaining the operation of the biometric information transfer system according to the first embodiment of the present invention.

FIG. 6 is a flowchart for explaining the operation of the biometric information transfer system according to the first embodiment of the present invention.

FIG. 7 is a flowchart for explaining the operation of a biometric information transfer system according to a second embodiment of the present invention.

FIG. 8 is a block diagram of a conventional biometric information transfer system.

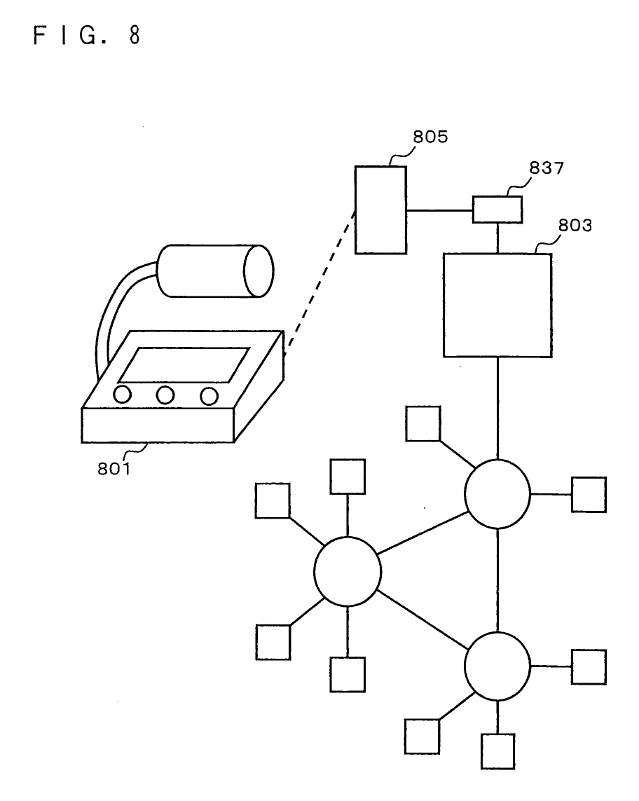

FIG. 9 illustrates an exemplary biometric information sensor device management table for a biometric information transfer system according to a third embodiment of the present invention.

FIG. 10 illustrates an exemplary e-mail header and an exemplary body for the biometric information transfer system according to the third embodiment of the present invention.

FIG. 11 is a flowchart for explaining the operation of the biometric information transfer system according to the third embodiment of the present invention.

FIG. 12 is a flowchart for explaining the operation of a biometric information transfer system according to a fourth embodiment of the present invention.

### BEST MODES FOR CARRYING OUT THE INVENTION

Hereinafter, embodiments of the biometric information transfer system according to the present invention will be described with reference to the drawings. In the following description, the same or similar elements are denoted by the same characters, and overlapping descriptions may be omitted.

### First Embodiment

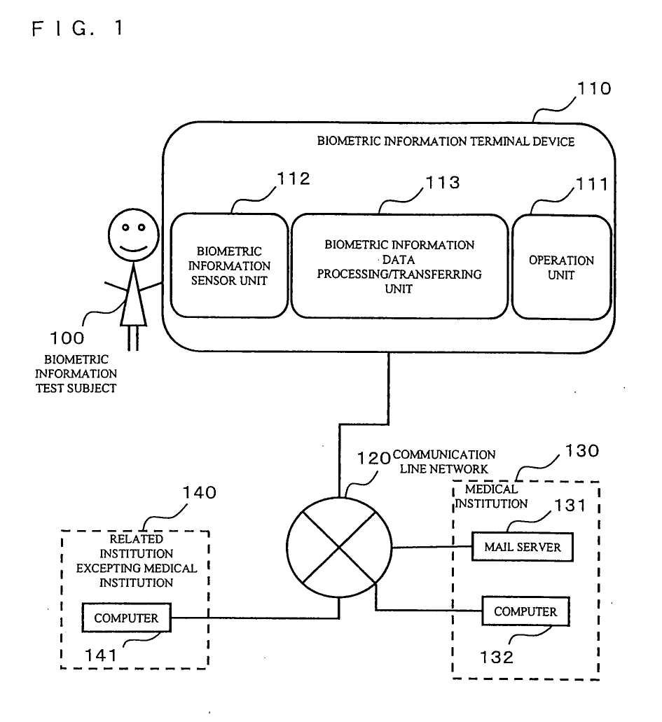

The configuration of the biometric information transfer system according to a first embodiment of the present invention is shown in FIG. 1. In FIG. 1, the biometric information transfer system according to the present embodiment includes a biometric information terminal device 110, a communication line network 120, a medical institution 130, which is a usual transfer destination, and a related institution 140 excepting the medical institution.

In the biometric information transfer system according to the present embodiment, a biometric information measurement result (data) is obtained by measuring a blood glucose level from a very small amount of blood using a biometric information sensor unit 112 acting as biometric information measurement means in the biometric information terminal device 110 to measure the blood glucose level, which is biometric information concerning a test subject 100. The biometric information measurement data measured by the biometric information sensor unit 112 is processed (converted) into e-mail format by a biometric information data processing/transferring unit 113 acting as data conversion means, and transferred over the public communication line network 120 to a mail server 131 in the designated medical institution 130 at a pre-registered usual transfer destination (e.g., address).

The medical institution 130 accesses the mail server 131 via a computer 132 to obtain the aforementioned biometric information measurement data in a conventional manner of obtaining e-mail, so that the blood glucose level of the test subject 100 can be checked on the computer 132.

Similarly, the biometric information can be transferred to the related institution 140, excepting the designated medical institution, at another pre-registered transfer destination (e.g., address), and in such a case, the biometric information can be checked on a computer 141 in the related institution 140 excepting the medical institution.

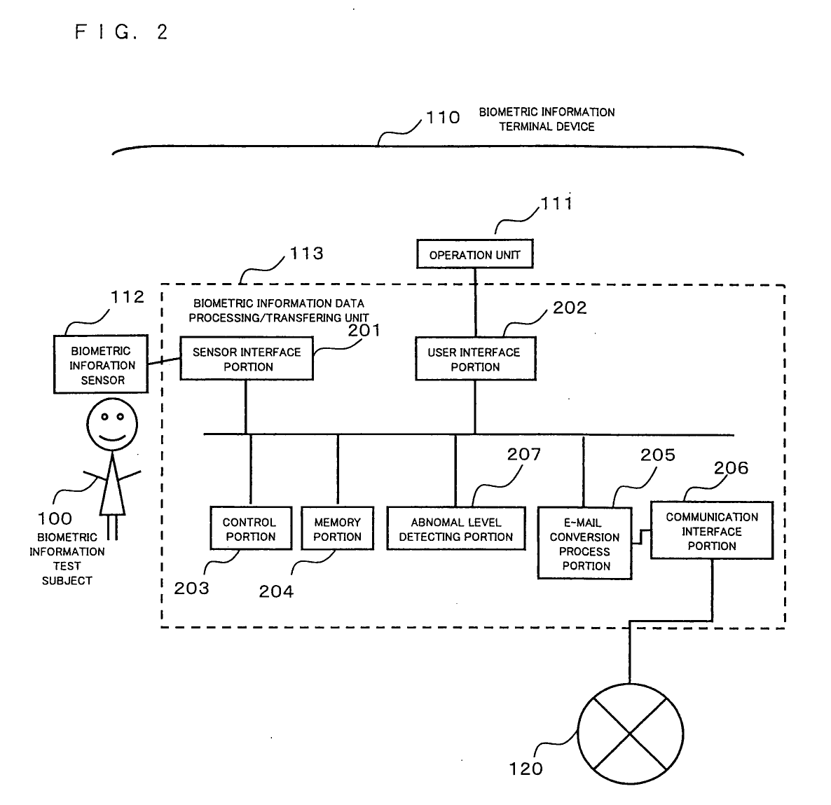

Referring to FIGS. 2 to 4, the first embodiment of the present invention will be described in further detail below.

FIG. 2 is a block diagram illustrating the configuration and functions of the biometric information terminal device 110 according to the present embodiment. The biometric information terminal device 110 is composed of an operation unit 111 acting as transfer instruction operation means, the biometric information sensor unit 112 acting as the biometric information measurement means, and the biometric information data processing/transferring unit 113.

The operation unit 111 is composed of an operation switch and an indicator (not shown).

In addition, the biometric information data processing/transferring unit 113 is composed of a sensor interface portion 201 acting as measurement condition detecting means for detecting a biometric information measurement condition, a control portion 203 acting as biometric information control means for controlling the biometric information, a memory portion 204, an abnormal level detecting portion 207 acting as abnormal level sensing means for sensing an abnormal level (an abnormal biometric information measurement result) as preparation for conversion (processing) of the biometric information measurement result into e-mail format, an e-mail conversion process portion 205 acting as data conversion means for converting the biometric information measurement result into e-mail format, a communication interface portion 206 acting as transfer destination information holding means for holding a preset transfer destination, and a user interface portion 202 for interfacing with the operation unit 111.

As described above, the blood glucose level data (biometric information measurement result) obtained from the test subject 100 by measurement using the biometric information sensor unit 112 is loaded in a predetermined format into the sensor interface portion 201, along with time stamp data for the date and time of measurement and measurement condition data. The sensor interface portion 201 temporarily buffers the loaded time-stamped blood glucose level data, and informs acquisition of the blood glucose level data to the control portion 203. At this time, the sensor interface portion 201 detects from the measurement condition data whether the measurement has been performed in a fasting state or two hours after a meal, and generates a measurement status flag.

Even when the blood glucose level data is successively loaded from the biometric information sensor unit 112, the sensor interface portion 201 effects its buffering function, such that the blood glucose level data is processed in the biometric information data processing/transferring unit 113 in accordance with the timing of the control portion 203. The control portion 203 analyzes the blood glucose level data obtained from the sensor interface portion 201, and sends the results to the memory portion 204, so that the results are accumulated and managed in a predetermined format, and the measurement status flags are also accumulated and managed in a similar manner.

For example, the control portion 203 analyzes the blood glucose level data based on three determination criteria by categorizing the blood glucose levels into 140 mg/dl or more, 120 mg/dl or more but less than 140 mg/dl, and less than 120 mg/dl.

In addition, the control portion 203 changes the categories (determination criteria) in accordance with the measurement status flag. Specifically, it is usually necessary to medically distinguish between the measurement performed two hours after a meal and the measurement performed in a fasting state, and therefore the test subject operates the switch (not shown) to input the measurement condition data via the biometric information sensor unit 112. For example, if the usual measurement is performed in a fasting state, the switch is pressed only when the measurement is performed two hours after a meal, in order to cause the measurement condition data to reflect that the measurement has been performed under a measurement condition different from the usual condition. As a result, the control portion 203 recognizes that the measurement has been performed two hours after a meal, based on the measurement status flag, and changes an analysis threshold, which is used for the usual measurement in a fasting state, to conduct an analysis based on different determination criteria. For example, three determination criteria are used by categorizing the blood glucose levels into 200 mg/dl or more, 170 mg/dl or more but less than 200 mg/dl, and less than 170 mg/dl. Note that the determination criteria are set by a person capable of conducting a diagnosis.

Blood glucose levels of 140 mg/dl or more measured in a fasting state and blood glucose levels of 200 mg/dl or more measured two hours after a meal are medically categorized as abnormal, and recognized as levels at which immediate medical treatment is needed. In addition, blood glucose levels of 120 mg/dl or more but less than 140 mg/dl measured in a fasting state, and blood glucose levels of 170 mg/dl or more but less than 200 mg/dl measured two hours after a meal are medically categorized as states in which counseling is needed, and recognized as nonurgent levels at which appropriate management is needed. Furthermore, blood glucose levels of less than 120 mg/dl measured in a fasting state and blood glucose levels of less than 170 mg/dl measured two hours after a meal are generally categorized as not abnormal (e.g., the Japan Diabetes Society, “Diabetes”, Vol. 45, Supplement 1 (2002)).

Accordingly, if any abnormal status as described above is sensed, a prompt report to the medical institution and a prompt medical response are required, and therefore, for example, the attention-drawing information “URGENT” is added to e-mail header information, in order to ensure distinction from e-mails concerning normal conditions. In addition, the state in which counseling is needed is less urgent, but must be unfailingly reported to the medical institution distinctly from others, and therefore, for example, the attention-drawing information “ATTENTION” is added to e-mail header information.

The control portion 203 executes the aforementioned analysis, and sends an analysis result to the memory portion 204 to generate a table with other management flags, thereby managing the biometric information measurement results (measurement data) (table management). The details of the table management will be described later in conjunction with the description of the memory portion 204.

Furthermore, the control portion 203 parses the contents of an instruction inputted by the test subject or suchlike from the operation unit 111 via the user interface portion 202, and performs appropriate processing in accordance with the instruction. For example, the contents inputted from the operation unit 111 include a transmission instruction to transfer the blood glucose level data to the medical institution or suchlike. The control portion 203 having received the transmission instruction transmits the blood glucose level data and so on, which are managed in the table within the memory portion 204, to the e-mail conversion process portion 205.

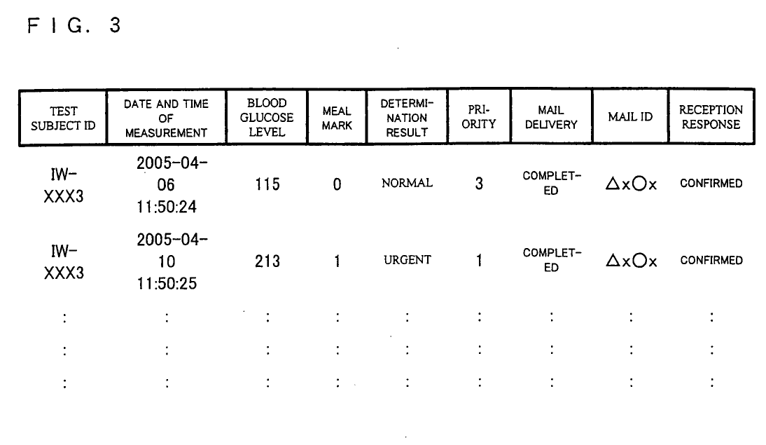

Here, an exemplary table for the blood glucose level data accumulated and managed in the memory portion 204 is shown in FIG. 3.

In the blood glucose level data table shown in FIG. 3, each entry under “TEST SUBJECT ID” is a reference number for identifying an individual test subject, and the number is determined between the medical institution and the test subject and pre-registered with the biometric information terminal device 110. Each entry under “DATE AND TIME OF MEASUREMENT” is the date and time of blood glucose level measurement, representing the date, hour, minute and second when the blood glucose level measured by the biometric information sensor unit 112 has been confirmed. Each entry under “BLOOD GLUCOSE LEVEL” is a value representing measurement data in units of mg/dl.

Each entry under “MEAL MARK” is a measurement status flag as described above, which is inputted by the test subject to the biometric information terminal device 110 at the time of measurement, and detected and generated from measurement condition data by the sensor interface portion 201. “0” denotes measurement performed in a fasting state, while “1” denotes measurement performed two hours after a meal. Each entry under “DETERMINATION RESULT” is decided by the control portion 203 determining blood glucose level data that is to be loaded from the biometric information sensor unit 112 into the table, and any one of the three indicators “URGENT”, “ATTENTION” and “NORMAL” is presented as described above.

Each entry under “PRIORITY” is reflected in e-mail, and any one of the above-described three grade values is inserted. For example, “URGENT”, “ATTENTION” and “NORMAL” can be set as priorities “1”, “2” and “3”, respectively, in connection with the determination result, but this is not restrictive.

Each entry under “MAIL DELIVERY” is an indicator to distinguish whether e-mail transfer to the medical institution 130 has been completed or not. For example, “COMPLETED” is indicated when the e-mail transfer has already been completed, while “UNCOMPLETED” is indicated when the e-mail transfer has not yet been completed.

Each entry under “MAIL ID” is added per e-mail transmission when the control portion 203 controls the memory portion 204 to transmit the biometric information measurement result to the e-mail conversion process portion 205.

In addition, each entry under “RECEPTION RESPONSE” indicates whether the medical institution 130, the receiver, has confirmed reception of the e-mail with the computer 132. For example, “CONFIRMED” is indicated when the reception has already been confirmed, while “UNCONFIRMED” is indicated when the reception has not yet been confirmed.

Next, as preparation for an e-mail conversion process, the abnormal level detecting portion 207 refers to “DETERMINATION RESULT” in the table for a target of the e-mail transfer to check whether data other than “NORMAL” is present, and determines its transfer destination. That is, the abnormal level detecting portion 207 also allows the data other than “NORMAL” to be transferred to a destination other than the medical institution 130.

As a conversion process for the purpose of transferring the blood glucose level data or suchlike in e-mail format, the e-mail conversion process portion 205 performs an encryption process and assigns e-mail header information (the destination, sender, title, priority, etc.) to the e-mail. Here, the e-mail conversion process portion 205 refers to “DETERMINATION RESULT” shown in FIG. 3, and determines the contents to be indicated in the title. For example, the title “[URGENT] Biometric information measurement value” is employed for the “URGENT” rank, or the title “[ATTENTION] Biometric information measurement value” is employed for the “ATTENTION” rank, such that “DETERMINATION RESULT” in the table shown in FIG. 3 is reflected in the title.

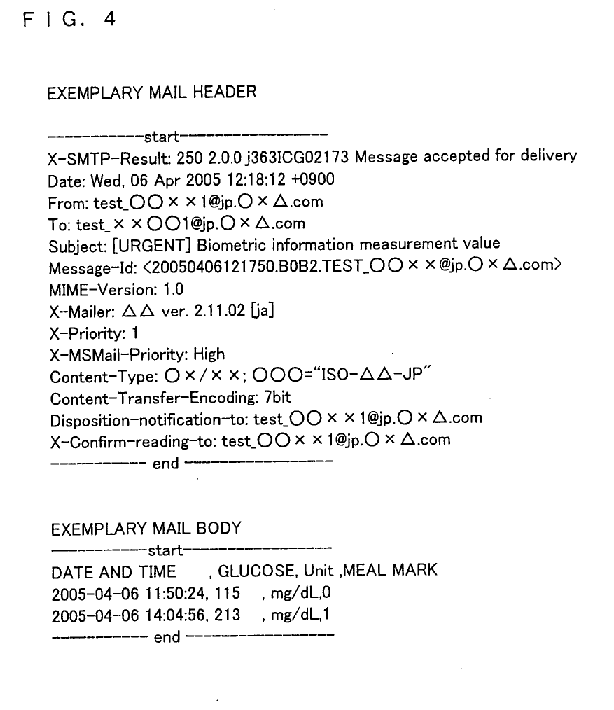

In addition, the e-mail conversion process portion 205 causes the e-mail header information to reflect the contents of “PRIORITY”. Here, an exemplary e-mail obtained by converting the biometric information measurement result into e-mail format is shown in FIG. 4. As shown in FIG. 4, the e-mail header indicates the transfer date “Date:”, the transferer's address “From:”, the transfer destination address “To:”, the title “Subject:” reflecting “DETERMINATION RESULT” shown in FIG. 3, and “X-Priority: 1” reflecting “PRIORITY”.

On the other hand, the contents of the e-mail body include a detailed biometric information measurement result. Exemplary contents of the body are shown in FIG. 4. As shown in FIG. 4, the body contains entries under “DATE AND TIME”, “GLUCOSE (blood glucose level)”, “Unit (unit of the blood glucose level)”, and “MEAL MARK”, and the entries under “MEAL MARK” indicate “0” for measurement performed in a fasting state, and “1” for measurement performed two hours after a meal.

In addition, the e-mail conversion process portion 205 causes the table shown in FIG. 3 to reflect the e-mail transfer history. Specifically, after confirming completion of mail transmission, the e-mail conversion process portion 205 adds “COMPLETED” as an entry under “MAIL DELIVERY”, and updates the indication under “RECEPTION RESPONSE” so as to reflect a response from the communication interface portion 206 in terms of whether the mail has been checked on the computer 132 in the medical institution 130.

The communication interface portion 206 transmits the e-mail obtained through the conversion process by the e-mail conversion process portion 205 over a public communication line to the transfer destination, which has been determined as preparation for the e-mail conversion process by the abnormal level detecting portion 207, in accordance with a communication protocol. That is, in the cases other than “NORMAL”, the transfer to a destination other than the medical institution 130 is performed. In addition, the communication interface portion 206 confirms that the medical institution 130 has received and responded to the e-mail, and reports the reception and response results to the e-mail conversion process portion 205.

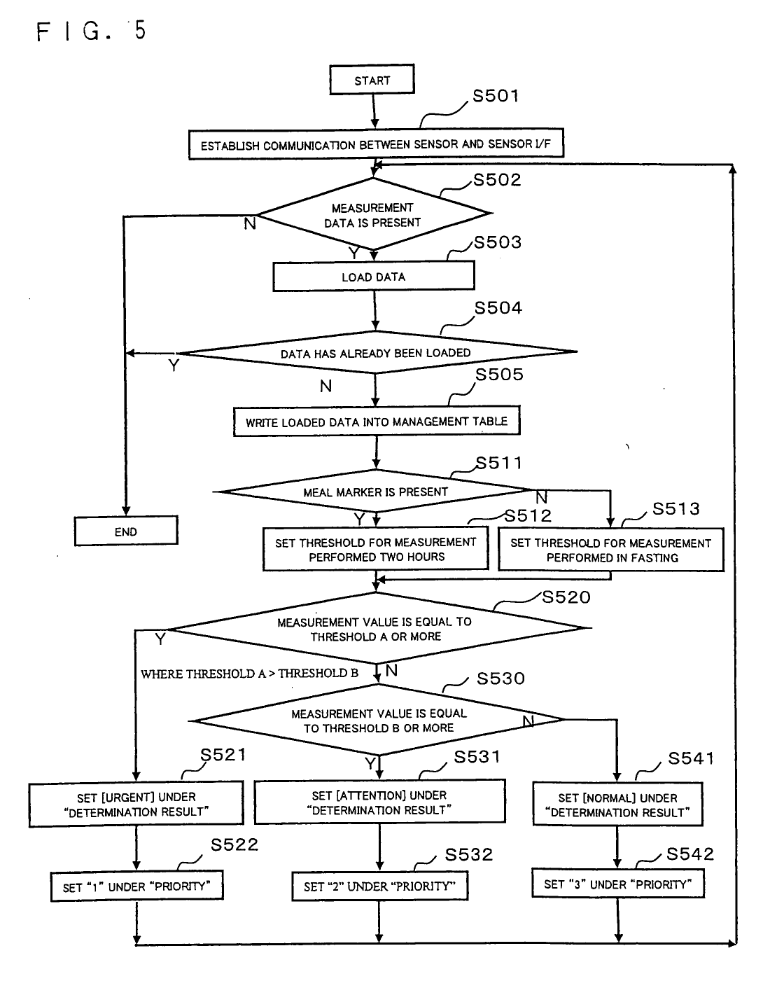

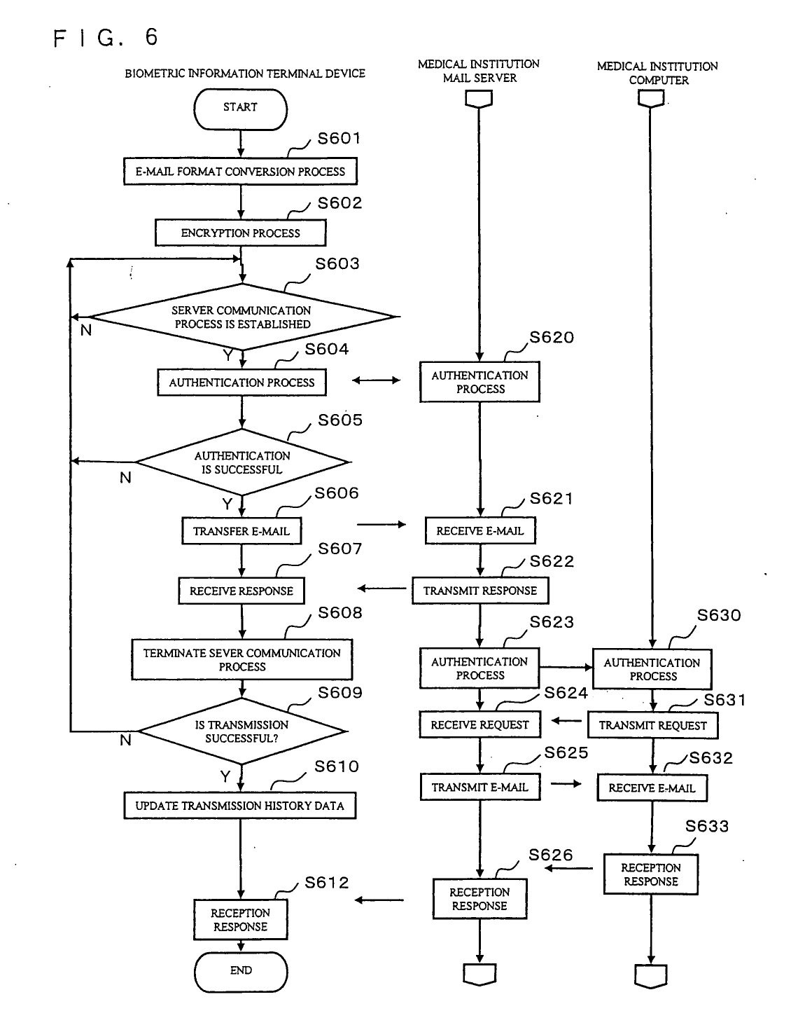

The operation of the biometric information transfer system thus configured according to the present embodiment will be described with reference to FIGS. 5 and 6. FIG. 5 illustrates a flowchart for explaining the procedure for loading the biometric information measurement results (measurement data) from the biometric information sensor unit 112 to the memory portion 204.

First, communication is established between the biometric information sensor unit 112 and the sensor interface portion 201 in a predetermined manner to transfer measurement data (S501), and when the communication is completely established, the presence or absence of the measurement data is checked (S502). In the absence of the measurement data, or if all the measurement data has already been loaded, the interaction between the biometric information sensor unit 112 and the sensor interface portion 201 is terminated.

In S503, the measurement data is loaded per measurement from the biometric information sensor unit 112, and matched against the table in the memory portion 204, with respect to entries under “TEST SUBJECT ID” and “DATE AND TIME OF MEASUREMENT”, to check whether the measurement data has already been present (S504), and only new measurement data is loaded into the table (S505). Subsequently, in order to analyze the measurement data, the presence or absence of an entry under “MEAL MARK” is checked (S511), and a determination criterion for analyzing the measurement data (e.g., threshold A in S520) is determined. Specifically, the entry “0” under “MEAL MARK” denotes measurement performed in a fasting state, while the entry “1” denotes measurement performed two hours after a meal.

Accordingly, as for the measurement performed in a fasting state denoted by “0” under “MEAL MARK”, threshold A in S520 is set to, for example, 140 mg/dl, while the threshold B in S530 is set to, for example, 120 mg/dl. In addition, as for the measurement performed two hours after a meal denoted by “1” under “MEAL MARK”, threshold A in S520 is set to, for example, 200 mg/dl, while threshold B in S530 is set to, for example, 170 mg/dl.

Consequently, in the case where the blood glucose level measured in a fasting state is 140 mg or more and the blood glucose level measured two hours after a meal is 200 mg/dl or more, control advances to S521, so that “URGENT” is recorded as an entry under “DETERMINATION RESULT” in the table (S521), and “1” is recorded as an entry under “PRIORITY” in the table (S522).

In addition, in the case where the blood glucose level measured in a fasting state is 120 mg/dl or more but less than 140 mg/dl and the blood glucose level measured two hours after a meal is 170 mg/dl or more but less than 200 mg/dl, control advances to S532, so that “ATTENTION” is recorded as an entry under “DETERMINATION RESULT” in the table (S531), and “2” is recorded as an entry under “PRIORITY” in the table (S531).

In the case where the blood glucose level measured in a fasting state is less than 120 mg and the blood glucose level measured two hours after a meal is less than 170 mg/dl, control advances to S541, so that “NORMAL” is recorded as an entry under “DETERMINATION RESULT” in the table (S541), and “3” is recorded as an entry under “PRIORITY” in the table (S542).

After any one of S522, S532 and S542 is completed, a process for loading the next measurement data is performed (S502). The measurement data loading process flow as described above is repeated until all the measurement data held in the biometric information sensor unit 112 is loaded into the memory portion 204.

Next, FIG. 6 illustrates a flowchart for explaining the procedure performed between the biometric information terminal device 110 and the medical institution 130 in accordance with the present embodiment to transfer the biometric information measurement results via e-mail. When “URGENT” or “ATTENTION” is present as an entry under “DETERMINATION RESULT”, the e-mail transfer is automatically performed upon completion of the loading to the table as described below. Also, in the cases of “URGENT” and “ATTENTION”, the transfer can be directed to a usual transfer destination except for usual destination (e.g., a family member or the related institution 140, such as a health center, which is preset along with the medical institution 130).

The blood glucose level data managed in the table within the memory portion 204, with related data, is converted into e-mail format by the e-mail conversion process portion 205 (S601). The biometric information measurement results are described in the body of the e-mail, and information required for transmission, the title reflecting the result of analyzing the blood glucose level data, and information denoting the priority level are added to the header of the e-mail.

Therefore, the table is referenced for entries under “DETERMINATION RESULT” and “PRIORITY”, and, for example, “URGENT” is indicated in the title when the entry under “DETERMINATION RESULT” is at an urgent level, while “ATTENTION” is indicated in the title when the entry under “DETERMINATION RESULT” is at an attention level. In addition, the entry under “PRIORITY” is reflected in an entry under “X-Priority”. After the e-mail format conversion process, an encryption process is performed (S602) to carry out processing for securing the e-mail.

The communication interface portion 206 establishes a server communication process over a public communication line in accordance with a communication protocol (S603). When the server communication process is established (Y in S603), the mail server 131 in the medical institution 130 performs an authentication process (S604, S620), and when the authentication is provided by the mail server 131 in the medical institution 130 (Y in S605), the e-mail transfer is started (S606). The mail server 131 in the medical institution 130 receives the transferred e-mail (S621). Upon reception, a response is transmitted from the mail server 131 in the medical institution 130 (S622), and the biometric information terminal device 110 receives the response (S607), and terminates the server communication process (S608).

Then, in S609, the success or failure of the e-mail transfer is checked based on the response obtained from the mail server 131 in the medical institution 130. In the case where the transfer is successful (Y in S609), transmission history data is updated (S610). Specifically, after completion of mail transmission is confirmed, “COMPLETED” is added as an entry under “MAIL DELIVERY” in the table. If the e-mail transfer is unsuccessful (N in S609), the processing is restarted from the establishment of the server communication process (S603).

Note that it is also possible that the mail server 131 in the medical institution 130 that has received the e-mail reports the e-mail reception to the computer 132 (see FIG. 1), such that the e-mail reception is informed to a physician or suchlike who uses the computer 132 (not shown).

As a result, the authentication process (S630) for the mail reception started by the physician or suchlike using the computer 132 in the medical institution 130 is performed between the mail server 131 and the computer 132 (S623). After the authentication is confirmed, a request is sent from the computer 132 in the medical institution 130 (S631), and the mail server 131 receives the request (S624) and transmits the aforementioned corresponding e-mail (S625).

Then, the e-mail is received by the computer 132 in the medical institution 130 (S632), so that the measurement data transferred from the biometric information terminal device 110 is delivered to the physician or suchlike. After confirming the e-mail, the physician or suchlike issues a reception response (S633), and the reception response is transmitted to the biometric information terminal device 110 via the mail server 131 (S626). The biometric information terminal device 110 having received the reception response records “CONFIRMED” as an entry under “RECEPTION RESPONSE” in the table, and the completion of the data transfer is indicated to the operation unit 111 via the user interface 202 (S612).

On the other hand, when the e-mail is transferred to the related institution 140, excepting the medical institution 130, the reception response does not have to be requested, and therefore the processing corresponding to S633, S626 and S612 may not be performed. Other process flows are similar to those in the case of the medical institution 130.

When the biometric information measurement values include any abnormal value, the biometric information transfer system thus configured according to the first embodiment of the present invention allows the e-mail header information to automatically reflect such a fact, thereby changing the title before sending, and furthermore allows the priority information to reflect the fact. Thus, the medical institution or suchlike that has received the e-mail can instantaneously recognize, from the title of the e-mail, that the e-mail is urgent and contains an abnormal measurement value, without opening the e-mail to confirm its contents, and therefore a prompt response can be made.

### Second Embodiment

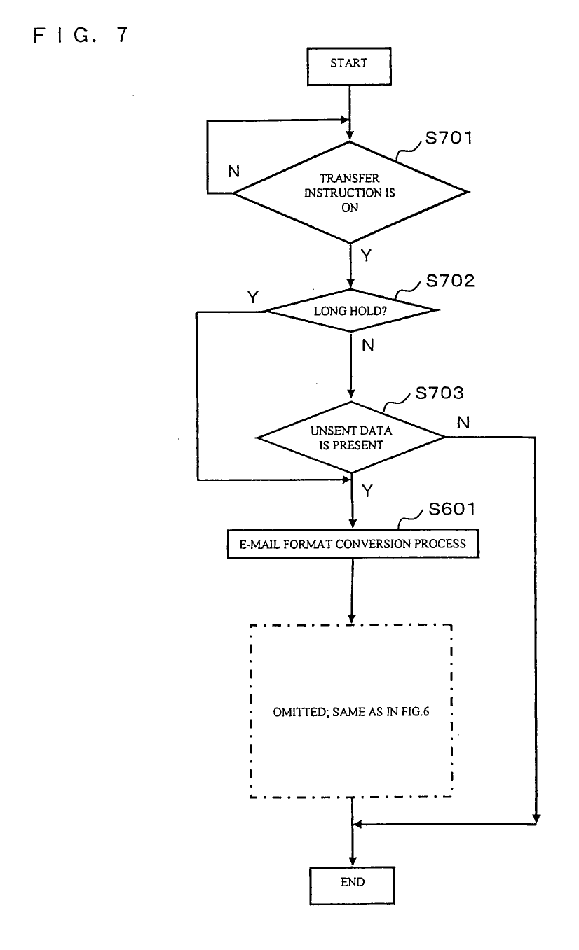

A biometric information transfer system according to the present embodiment is the same as that in the first embodiment, except its operation method, and therefore the operation of the biometric information transfer system according to the present embodiment will be described with reference to FIG. 7.

As a result of analyzing the blood glucose level data loaded from the biometric information sensor unit 112 as described in the first embodiment, if neither “URGENT” nor “ATTENTION” is found, the loaded blood glucose level data is not automatically transferred via e-mail. In addition, when it is desired to transfer the blood glucose level data that has not yet been transferred, or retransfer the blood glucose level data that has already been transferred, the test subject can perform the following operation to transfer the blood glucose level data via e-mail.

When an e-mail transfer instruction switch (not shown) provided in the operation means 111 of the biometric information terminal device 110 is pressed, the pressing of the switch is sensed by the control portion 203 via the user interface portion 202 (S701). At this time, the control portion 203 determines whether the switch has been held for a long time.

When such a long hold is not sensed (N in S702), the control portion 203 searches the table in the memory portion 204 for any entry “UNCOMPLETED” under “MAIL DELIVERY” (S703), and if there is data that has not yet been sent (Y in S703), the unsent data is sent to the e-mail conversion process portion 205, and converted into e-mail format (S601). Thereafter, the e-mail transfer process is performed in the same manner as in the first embodiment.

On the other hand, when the long hold is sensed (Y in S702), the control portion 203 determines that retransfer is requested, and the measurement data present in the table within the memory portion 204 is sequentially sent to the e-mail conversion process portion 205, and converted into e-mail format (S601). In S703, if there is no unsent data, the operation is terminated without any processing (N in S703).

The biometric information transfer system thus configured according to the second embodiment of the present invention allows all the biometric information measurement data to be transferred to the medical institution 130. At the same time, it is also possible to retransfer as necessary the data that has already been transferred, thereby increasing the reliability of the biometric information transfer. While the foregoing has been described with respect to the case where the determination criteria for the blood glucose level measurement data involve two thresholds, the number of thresholds can be increased. For example, low blood glucose levels may also be targeted and the blood glucose level data may be classified into “URGENT” or “ATTENTION”.

### Third Embodiment

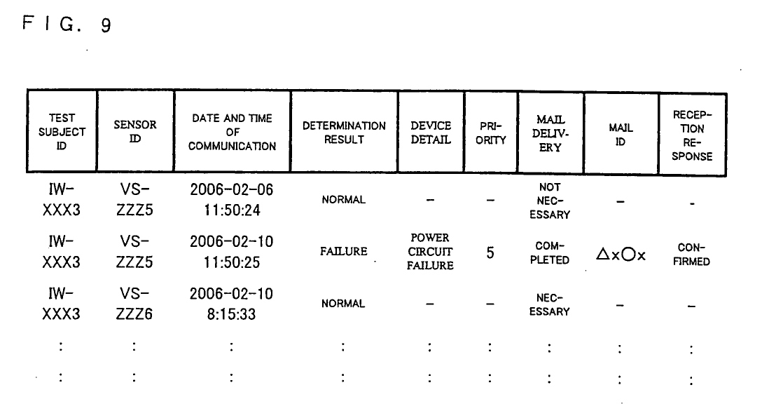

A biometric information transfer system according to the present embodiment is the same as that in the first embodiment, except its operation method, and therefore the operation of the biometric information transfer system according to the present embodiment will be described with reference to FIGS. 9 to 11. Specifically, the biometric information transfer system according to the present embodiment is the same as that shown in FIG. 1, and the block configuration of the biometric information terminal device is the same as that shown in FIG. 2.

An example of the table stored in the memory portion 204 in the present embodiment is shown in FIG. 9. This table contains information for managing the biometric information sensor unit 112 (see FIG. 1). In the table shown in FIG. 9, each entry under “SUBJECT ID” is a reference number for identifying an individual test subject, which is determined by the medical institution 130 and pre-registered with the biometric information terminal device 110.

Each entry under “SENSOR ID” is information stored in biometric information sensor unit 112 to uniquely identify the biometric information sensor unit 112. In addition, each entry under “DATE AND TIME OF COMMUNICATION” indicates the date and time at which communication is performed between the sensor interface portion 201 and the biometric information sensor unit 112 within the biometric information terminal device 110, the date and time being indicated by the date, hour, minute and second in the biometric information terminal device 110. Note that the date, hour, minute and second may be those in the biometric information sensor unit 112.

Each entry under “DETERMINATION RESULT” is decided by the control portion 203 determining the status of the biometric information sensor unit 112 that is loaded from the biometric information sensor unit 112 to the table. For example, one of three categories “NORMAL”, “FAILURE” and “LOW BATTERY” is indicated as an entry under “DETERMINATION RESULT”. Note that the three are merely illustrative, and a larger number of categories may be employed. Accordingly, in such a case, the control portion 203 functions as status detecting means for detecting the status of the biometric information sensor unit 112 acting as the biometric information measurement means.

Each entry under “DEVICE DETAIL” is detailed information obtained from the biometric information sensor unit 112 when the biometric information sensor unit 112 has a failure. Each entry under “PRIORITY” indicates a criterion to be reflected in e-mail, which is selected from among the five grades as described in the first embodiment.

Each entry under “MAIL DELIVERY” is used to distinguish whether e-mail transfer to the medical institution 130 is necessary, and when the mail transfer is necessary, it is used to distinguish between sent and unsent. In addition, each entry under “MAIL ID” is added per e-mail transmission when the control portion 203 controls the memory portion 204 to transmit the measurement data to the e-mail conversion process portion 205.

Each entry under “RECEPTION RESPONSE” indicates that the medical institution 130, the receiver, has confirmed reception of the e-mail with the computer 132. However, when the mail delivery is not necessary, entries under “PRIORITY”, “MAIL ID” and “RECEPTION RESPONSE” are not necessary, and therefore in FIG. 9, “-” is indicated to represent that no indication is required.

As preparation for the e-mail conversion process, the abnormal level detecting portion 207 refers to the table for the entry under “DETERMINATION RESULT” that is targeted for the e-mail transfer, to check whether there is any measurement data other than “NORMAL”, and determine a transfer destination. Specifically, in the case of “NORMAL”, the e-mail transfer is not performed, but in the cases other than “NORMAL”, the e-mail transfer is performed. The e-mail transfer can be performed for at least one destination from among the medical institution 130 and the institution 140 excepting the medical institution, or the e-mail transfer can be performed for a plurality of destinations.

The e-mail conversion process portion 205 performs an encryption process as a conversion process for the purpose of transferring the blood glucose level measurement data or suchlike in e-mail format, and assigns e-mail header information (destination, sender, title, priority, mail-opened confirmation request, etc.). Here, the table shown in FIG. 9 is referenced for entries under “DETERMINATION RESULT” and “DEVICE DETAIL” in order to determine the contents to be indicated in the title of the e-mail header information. For example, when the entry under “DETERMINATION RESULT” is at a “FAILURE” rank, and the entry under “DEVICE DETAIL” is “POWER CIRCUIT FAILURE”, “[FAILURE] Power circuit failure of biometric information sensor” is indicated in the e-mail header title. In addition, when the entry under “DETERMINATION RESULT” is at a “LOW BATTERY” rank, “[LOW BATTERY] Biometric information sensor device” is indicated in the e-mail header title. In addition, the e-mail conversion process portion 205 causes the e-mail header information to reflect the contents of the entry under “PRIORITY”.

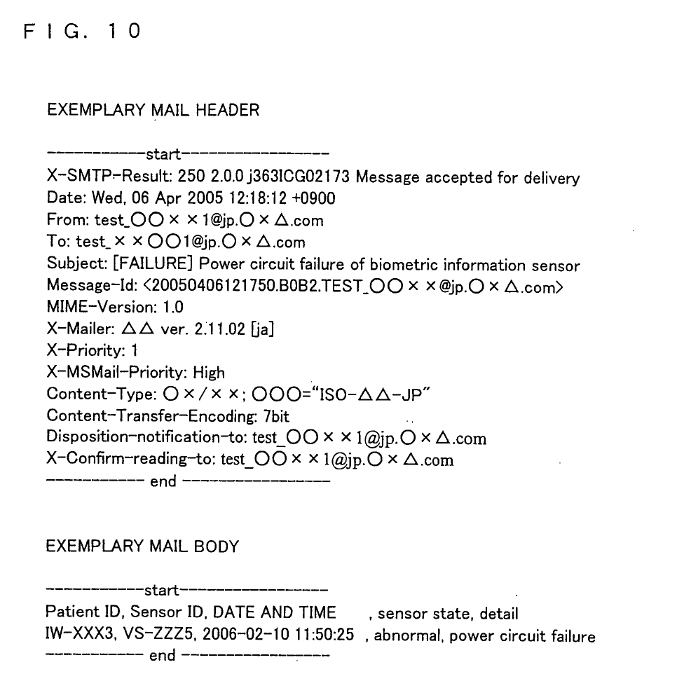

Here, FIG. 10 illustrates an exemplary e-mail header obtained by converting the measurement data into e-mail format. The mail header shown in FIG. 10 indicates the transfer date “Date:”, the transferer's address “From:”, the transfer destination address “To:”, the title “Subject:” reflecting the entry under “DETERMINATION RESULT” shown in FIG. 3, and “X-Priority:” reflecting the entry under “PRIORITY” shown in FIG. 3.

In addition, when the entry under “DETERMINATION RESULT” is other than “NORMAL”, and it is desired to receive a mail-opened confirmation mail from the transfer destination, “Disposition-notification-to” and “X-Confirm-reading-to:” are added to the mail header in order to send a mail-opened confirmation request. In such a case, the mail address at which to receive the confirmation mail is further set after the mail-opened confirmation request header. However, not all e-mail software applications are necessarily provided with the mail-opened confirmation request function, and therefore it is necessary to confirm in advance whether the mail software application on the computer 132 in the medical institution 130 supports such a function.

FIG. 10 also shows an exemplary body contained in the e-mail obtained by converting the measurement data into e-mail format. There are shown an entry under “Patient ID”, which is an ID for uniquely identifying the test subject (patient), an entry under “Sensor ID”, which is an ID for uniquely identifying the biometric information sensor, an entry under “DATE AND TIME”, which is a communication date and time at which the communication between the biometric information sensor unit 112 and the sensor interface portion 201 has been performed, an entry under “Sensor state”, which indicates the device status of the biometric information sensor unit 201, and an entry under “Detail”, which indicates the detailed status of the biometric information sensor unit 112.

In addition, the e-mail conversion process portion 205 causes the table shown in FIG. 9 to reflect the e-mail transfer history. Specifically, after completion of mail transmission is confirmed, “COMPLETED” is added as an entry under “MAIL DELIVERY”, and an ID for identifying the sent mail is added as an entry under “MAIL ID”. When the mail software application on the computer 132 in the medical institution 130 supports the mail-opened confirmation request, the contents of the entry under “RECEPTION RESPONSE” are updated to reflect a response from the communication interface portion 206.

At this time, the communication interface portion 206 transmits the e-mail, which is generated through a conversion process by the e-mail conversion process portion 205, to the transfer destination, which is determined as preparation for the e-mail conversion process by the abnormal level detecting portion 207, over a public communication line in accordance with a communication protocol.

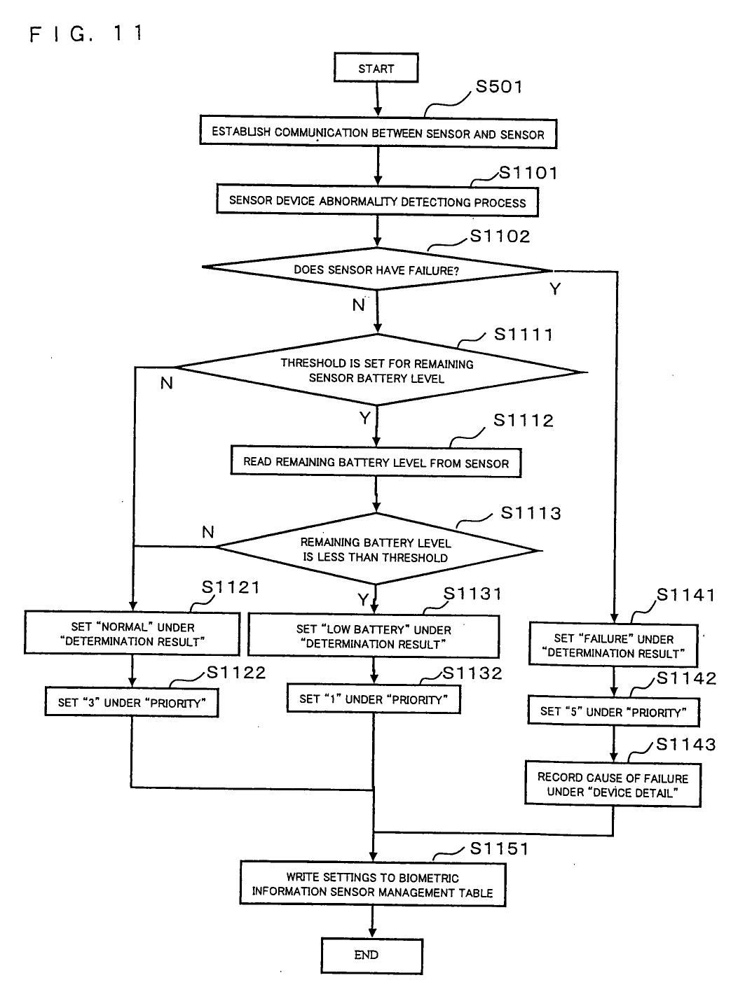

The operation of the biometric information transfer system thus configured according to the present embodiment will be described with reference to FIG. 11. FIG. 11 is a flowchart illustrating the procedure of loading the status of the biometric information sensor unit 112 to the memory portion 204 in accordance with the present embodiment. First, communication is established between the biometric information sensor unit 112 and the sensor interface portion 201 in a predetermined manner to transfer measurement data (S501). When the communication is completely established, a process for detecting the abnormality of the biometric information sensor unit 112, which affects measurement results, is performed in the biometric information sensor unit 112 (S1101).

As a result of the abnormality detection process by the biometric information sensor unit 112, the presence or absence of failure in the biometric information sensor unit 112 is checked (S1102). In the absence of abnormality, a threshold setting for the remaining battery level of the biometric information sensor unit 112 is confirmed (S1111). In S1111, if any threshold is set for the remaining battery level, the remaining battery level is read from the biometric information sensor unit 112 (S1112), and the remaining battery level of the biometric information sensor unit 112 is compared to the threshold (S1113).

With the above processes, when the biometric information sensor unit 112 does not indicate a failure and the remaining battery level is equal to or more than the threshold being set, “NORMAL” is recorded as an entry under “DETERMINATION RESULT” in the table (S1121), and “3” is set as an entry under “PRIORITY” (S1122). In addition, in S1113, if the remaining battery level is determined to be less than the threshold, “LOW BATTERY” is recorded as an entry under “DETERMINATION RESULT” in the table (S1131), and “1” is set as an entry under “PRIORITY” (S1132).

On the other hand, in S1102, if the biometric information sensor unit 112 is determined to have a failure, “FAILURE” is recorded as an entry under “DETERMINATION RESULT” in the table (S1141), “5” is set as an entry under “PRIORITY” (S1142), and the cause of failure in the biometric information sensor unit 112 is recorded as an entry under “DEVICE DETAIL” (S1143). When any one of S1122, S1132 and S1143 is completed, the set values are written to the table (S1151).

The transfer flow of the biometric information via e-mail between the biometric information terminal device 110 and the medical institution 130 in the present embodiment is the same as that in the first embodiment shown in FIG. 6, and therefore the description thereof will be omitted. In addition, while the present embodiment has been described with respect to the case of sensing the abnormality of the biometric information sensor device (biometric information sensor unit 112), which affects measurement values, it is also possible to sense the abnormality of the biometric information measurement result in the first embodiment and cause the e-mail to reflect both of the abnormalities.

### Fourth Embodiment

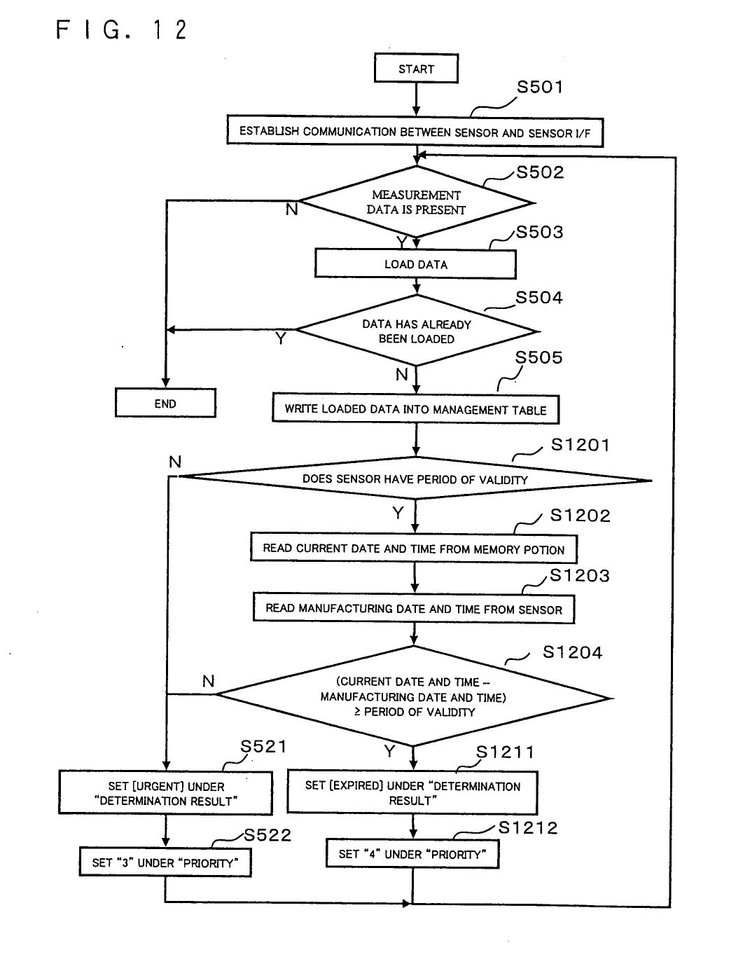

A biometric information transfer system according to the present embodiment is the same as that in the third embodiment, except for its operation method, and therefore the operation of the biometric information transfer system according to the present embodiment will be described with reference to FIG. 12. Specifically, the biometric information transfer system according to the present embodiment is the same as that shown in FIG. 1, the block configuration of the biometric information terminal device is the same as that shown in FIG. 2, and the table shown in FIG. 9 is used.

FIG. 12 is a flowchart illustrating the procedure of loading the status of the biometric information sensor unit 112 to the memory portion 204 in accordance with the present embodiment. First, communication is established between the biometric information sensor unit 112 and the sensor interface portion 201 in a predetermined manner to transfer data (S501), and when the communication is completely established, the presence or absence of measurement data is checked (S502). In the absence of measurement data, or when all the measurement data has already been loaded, the interaction between the biometric information sensor unit 112 and the sensor interface portion 201 is terminated.

In S503, the measurement data is loaded per measurement from the biometric information sensor unit 112, and an entry under “SUBJECT ID” and the date and time of measurement in the table within the memory portion 204 are referenced to confirm whether the measurement data has already been present (S504). Specifically, the contents in the first row of the table shown in FIG. 9 are identified based on the subject ID and the date and time of measurement. Only measurement data that has not yet been loaded is loaded to the table (S505).

The control portion 203 confirms whether a period of validity is set for the biometric information sensor unit 112 (S1201), the current date and time is read from the memory portion 204 of the biometric information terminal device 110 (S1202), and the “manufacturing date and time” of the biometric information sensor unit 112 provided in the biometric information terminal device 110 is read from the sensor unit (S1203). The difference between the “current date and time” and the “manufacturing date and time” is obtained and compared to the period of validity being set (S1204). Accordingly, in this case, the control portion 203 also functions as manufacturing date detecting means for detecting the manufacturing date and time of the biometric information sensor unit 112, which acts as the biometric information measurement means, and determining the difference between the current date and time and the manufacturing date and time as well as determining whether the period of validity of the biometric information sensor unit 112 has expired.

If the result of the comparison is that the period of validity of the biometric information sensor unit 112 has expired, “EXPIRED” is set as an entry under “DETERMINATION RESULT” in the table (S1211), and “4” is set as an entry under “PRIORITY” (S1212). On the other hand, if the period of validity has not expired, or the period of validity is not set, “NORMAL” is set as an entry under “DETERMINATION RESULT” in the table (S521), and “3” is set as an entry under “PRIORITY” (S522).

The transfer flow of the biometric information measurement results via e-mail between the biometric information terminal device 110 and the medical institution 130 is the same as that shown in FIG. 6, and therefore the description thereof will be omitted. In addition, while the present embodiment has been described with respect to the case where the abnormal status of the biometric information sensor unit 112 represents an expired period of validity, the abnormality of the biometric information measurement results as in the first embodiment may also be reflected in the e-mail.

While the foregoing has been described in conjunction with representative embodiments of the present invention, various modifications can be made to the design of the present invention within the spirit of the invention. For example, it is possible to suitably combine components of the first through fourth embodiments.

### INDUSTRIAL APPLICABILITY

As described above, according to the present invention, when the biometric information measurement value is abnormal, or the biometric information measurement device is in an abnormal state that affects measurement results, for example, the title of the e-mail header information is changed or the priority information is added to the e-mail. Accordingly, the receiver such as a medical institution can instantaneously recognize, merely by the header information, that the e-mail contains an abnormal measurement value, without opening the e-mail to confirm its contents, so that a prompt response can be made. Therefore, the present invention is useful as, for example, a biometric information transfer system for measuring the biometric information and remotely transferring it in e-mail format to, for example, a medical institution or a related institution via a communication line network.

1. A biometric information transfer system for transferring a biometric information measurement result in e-mail format to a mail server via a telecommunication line, the system comprising a biometric information terminal device, which includes:
biometric information measurement means for measuring biometric information;
control means for analyzing and managing the biometric information based on a determination criterion; and
data conversion means for converting the biometric information measurement result into e-mail format, wherein,
the data conversion means assigns attention-drawing information to the e-mail in accordance with the biometric information measurement result.

2. The biometric information transfer system according to claim 1, wherein the biometric information terminal device further includes condition detecting means for detecting a measurement condition for the biometric information, and the determination criterion is determined in accordance with the measurement condition.

3. The biometric information transfer system according to claim 1, wherein,
the biometric information terminal device further includes transfer destination information holding means for holding at least a first transfer destination of the e-mail, and
the data conversion means assigns at least the first transfer destination to the e-mail.

4. The biometric information transfer system according to claim 3, wherein,
the biometric information terminal device further includes abnormality sensing means for sensing an abnormality of the biometric information measurement result, and
when the abnormality sensing means senses one or more abnormalities, the data conversion means assigns the e-mail a second transfer destination different from the first transfer destination.

5. The biometric information transfer system according to claim 1, wherein,
the biometric information terminal device further includes transfer operation means for giving a transfer instruction, and
in accordance with the instruction from the transfer operation means, the data conversion means converts the biometric information measurement result into the e-mail format, and starts transferring the e-mail.

6. The biometric information transfer system according to claim 1, wherein the data conversion means assigns a mail-opened confirmation request to the e-mail in accordance with the biometric information measurement result.

7. The biometric information transfer system according to claim 1, wherein,
the biometric information terminal device further includes status detecting means for detecting a status of the biometric information measurement means, and
the data conversion means assigns attention-drawing information to the e-mail in accordance with the status of the biometric information measurement means detected by the status detecting means.

8. The biometric information transfer system according to claim 1, wherein,
the biometric information terminal device further includes manufacturing date detecting means for detecting a manufacturing date and time of the biometric information measurement means, determining a difference between a current date and time and the manufacturing date and time, and determining whether a period of validity of the biometric information measurement means has expired, and
the data conversion means assigns the attention-drawing information to the e-mail in accordance with whether the period of validity has expired.
